(19) United States
(12) Patent Application Publication
(10) Pub. No.: US 2011/0151919 A1
(43) Pub. Date: Jun. 23, 2011

(54) METHOD AND APPARATUS FOR MEASURING SIGNAL RECEIVED FROM NEIGHBOR CELL

(75) Inventor: Eun-Jeong SHIN, Daejeon-si (KR)

(73) Assignee: Electronics and Telecommunications Research Institute, Daejeon (KR)

(21) Appl. No.: 12/847,576

(22) Filed: Jul. 30, 2010

(30) Foreign Application Priority Data
Dec. 18, 2009 (KR) 10-2009-0127318

(51) Int. Cl. H04W 36/24; H04W 24/00

(52) U.S. Cl. 455/525; 455/67.11

(57) ABSTRACT

A method and apparatus for measuring a signal received from a neighbor cell is provided. The method includes selecting at least one target cell from among the at least one neighbor cell and measuring strength and received power of a signal received from the at least one target cell.

### CROSS-REFERENCE TO RELATED APPLICATION

This application claims the benefit under 35 U.S.C. §119(a) of Korean Patent Application No. 10-2009-0127318, filed on Dec. 18, 2009, the entire disclosure of which is incorporated herein by reference for all purposes.

### BACKGROUND

1. Field

The following description relates to handover in mobile communication and, more particularly, to a technology for measuring a signal received from a neighbor cell.

2. Description of the Related Art

In mobile communication, when a mobile communication terminal is powered on and is in an idle mode, the mobile communication terminal selects a serving cell to receive communication services from a base station within the serving cell. The term idle mode indicates that a mobile communication terminal is in a condition to receive or be ready to receive control information of a cell that provides communication services to the mobile communication terminal. The serving cell is selected for the mobile communication terminal to be registered with a communication network so that the mobile communication terminal may receive communication services from a base station within the serving cell.

On the other hand, the strength or quality of a signal transmitted between a mobile communication terminal and a base station within a serving cell may be decreased due to movement of the mobile communication terminal. For example, signal-to-noise ratio (SNR) of a signal which is transmitted from a serving cell may be decreased below a threshold level. In this case, the mobile communication terminal needs to reselect a neighbor cell neighboring the serving cell to maintain data transmission quality.

### SUMMARY

The following description relates to a technology for selecting a neighbor cell neighboring a serving cell of a mobile communication terminal and measuring a signal received from the neighbor cell.

In one general aspect, there is provided a method of measuring a signal received from at least one neighbor cell neighboring a serving cell for a mobile communication terminal in mobile communication, the method including: selecting at least one target cell from among the at least one neighbor cell; and measuring strength and received power of a signal received from the at least one target cell.

Measuring the strength and received power of a signal received from the at least one target cell may include: measuring a received signal strength indicator (RSSI) indicating the strength of the received signal; and measuring reference symbol received power (RSRP) indicating the received power of a specific position of each slot of a sub-frame of the received signal.

In another general aspect, there is provided a mobile communication terminal measuring a signal received from at least one neighbor cell neighboring a serving cell for the mobile communication terminal in mobile communication, including: a target cell selecting unit selecting at least one target cell from among the at least one neighbor cell; and a received signal measuring unit measuring strength and received power of a signal received from the at least one target cell.

According to still another aspect, there is provided a mobile communication terminal measuring a signal received from at least one neighbor cell neighboring a serving cell for the mobile communication terminal in mobile communication, including: a reference symbol buffer extracting a reference symbol signal from the signal received from the at least one neighbor cell and storing the reference symbol signal therein; a Fast Fourier Transform (FFT) block performing Fast Fourier Transform on the stored reference symbol; an RSSI controller accumulating received signal strength of a resource element within a measurement bandwidth with respect to the reference symbol signal which has been subjected to the FFT operation; and an RSRP controller extracting a reference sub-carrier with respect to the reference symbol signal which has been subjected to the FFT operation, accumulating received power of the extracted reference sub-carrier, and measuring reference symbol received power (RSRP) including the received power of the accumulated reference sub-carrier and noise power.

Other features and aspects will be apparent from the following detailed description, the drawings, and the claims.

### BRIEF DESCRIPTION OF THE DRAWINGS

FIG. 1 is a block diagram illustrating an example of a mobile communication terminal according to an exemplary embodiment of the present invention.

FIG. 2 is a block diagram illustrating an example of a mobile communication terminal for measuring a signal received from a neighbor cell according to an exemplary embodiment of the present invention.

FIG. 3 is a circuit diagram illustrating an example of a mobile communication terminal for measuring a signal received from a neighbor cell according to an exemplary embodiment of the present invention.

FIG. 4 is a flowchart illustrating an antenna path and a time sharing process per symbol in a mobile communication terminal according to an exemplary embodiment of the present invention.

FIG. 5 is a flowchart illustrating an example method of measuring a signal received from a neighbor cell at a mobile communication terminal according to an exemplary embodiment of the present invention.

Throughout the drawings and the detailed description, unless otherwise described, the same reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

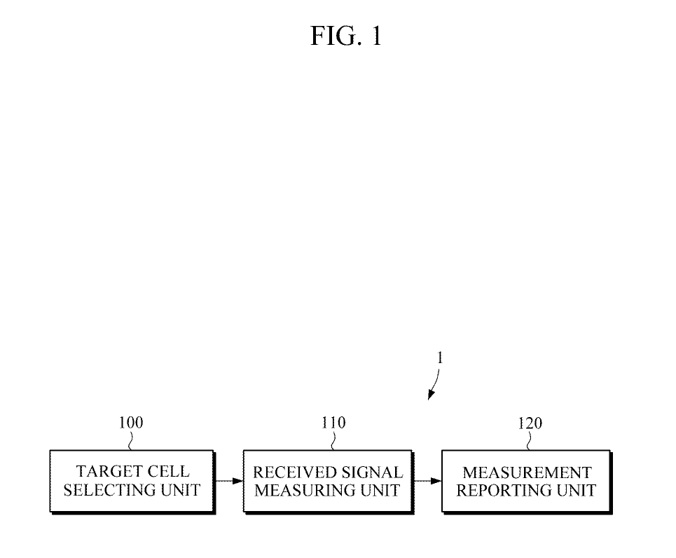

FIG. 1 is a block diagram illustrating an example of a mobile communication terminal 1 according to an exemplary embodiment of the present invention.

The mobile communication terminal 1 includes a target cell selecting unit 100, a received signal measuring unit 110 and a measurement reporting unit 120.

The target cell selecting unit 100 targets one of neighbor cells to measure received signal strength and power in mobile communication. More specifically, when the received signal strength or quality between the mobile communication terminal 1 and a base station of a serving cell is decreased due to movement of the mobile communication terminal 1, the target cell selecting unit 100 selects the target cell to maintain data transmission quality.

In one embodiment, the target cell selecting unit 100 receives a neighbor cell list (NCL) from a base station of a serving cell and refers to the NCL to select a target cell. In another embodiment, the target cell selecting unit 100 selects the target cell through a scanning or synchronization process.

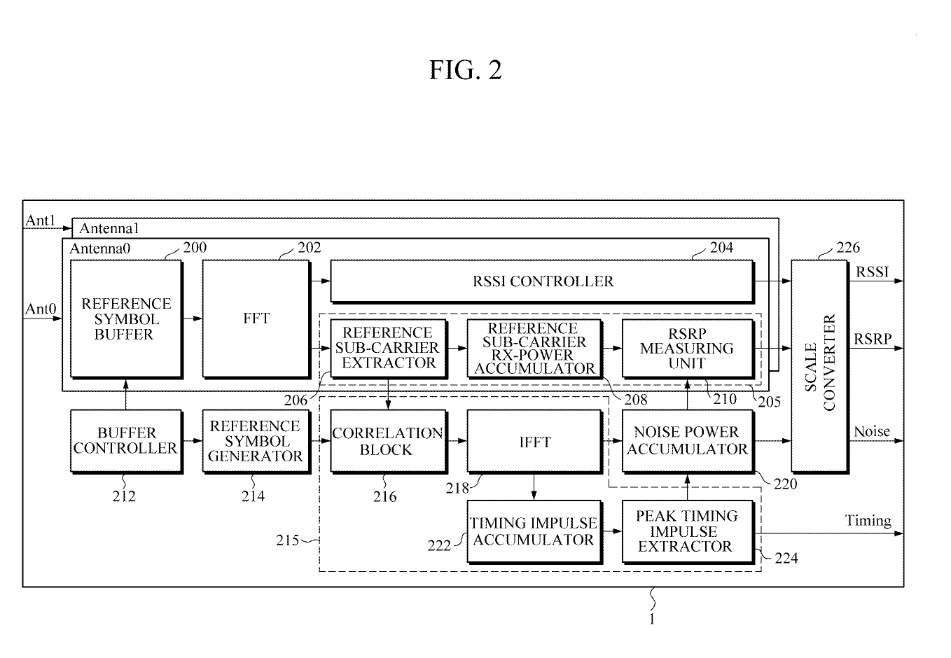

The received signal measuring unit 110 measures the strength and power of a signal received from the target cell selected by the target cell selecting unit 100. In one embodiment, the received signal measuring unit 110 measures a received signal strength indicator (RSSI) indicating the strength of a received signal. Further, the received signal measuring unit 110 measures a reference symbol received power (RSRP) indicating the received power of a specific position of each slot of a sub-frame of the received signal. Further, the received signal measuring unit 110 may measure noise power and timing offset of the received signal. A process by which the received signal measuring unit 110 measures a signal received from a neighbor cell will be described with reference to FIG. 2.

The measurement reporting unit 120 reports a measured result of the received signal measuring unit 110 to a radio resource control (RRC) layer. The RRC layer, which is defined on a control plane, controls a logical channel, a transport channel and a physical channel in association with configuration, reconfiguration and release in mobile communication. The mobile communication terminal 1 uses the measured result to select a neighbor cell which provides communication services.

Since the measurement report is made when the signal strength or quality between the serving cell and the mobile communication terminal 1 is decreased, accurate measurement results of neighbor cells need to be quickly reported. Further, when an inter cell is measured with the RRC connected or the measurement is made after an RF module is powered on in an idle mode, the mobile communication terminal 1 needs to promptly report the measurement result to the RRC.

According to an exemplary embodiment of the present invention, when the signal strength or quality between the serving cell and the mobile communication terminal 1 is decreased, the received signal measuring unit 110 can quickly measure the strength and power of a signal received from a neighbor cell and the measurement reporting unit 120 can promptly report the measurement result to the RRC.

FIG. 2 is a block diagram illustrating an example of a mobile communication terminal 1 for measuring a signal received from a neighbor cell according to an exemplary embodiment of the present invention.

Referring to FIG. 2, the mobile communication terminal 1 includes a reference symbol (RS) buffer 200, a Fast Fourier Transform (FFT) block 202, an RSSI controller 204, an RSRP measuring unit 210, a buffer controller 212, a reference symbol (RS) generator 214, a timing offset controller 215, a noise power accumulator 220 and a scale converter 226.

In one embodiment, the mobile communication terminal 1 stores a neighbor cell list (NCL) about neighbor cells neighboring a serving cell and begins measuring the neighbor cell if signal-to-noise ratio (SNR) of the serving cell falls below a threshold level. The mobile communication terminal 1 compares its own clock with timing offset of a detected neighbor cell regardless of timing of the serving cell to calculate a symbol sync point and a radio frame start point of a target cell. Further, the mobile communication terminal 1 calculates a position of a reference symbol (RS) from the calculated result, and calculates a position of a sub-carrier including a reference signal within the RS using a target cell ID.

The RS buffer 200 extracts an RS signal from a signal received from a target cell among neighbor cells and stores the RS signal therein. The RS buffer 200 stores the RS signal when the RS signal of the target cell is received. The RS signal is a signal prearranged between the mobile communication terminal 1 and a base station of the neighbor cell to estimate a condition of a random channel. The RS signal needs to be transmitted enough to estimate a change of a channel and should not be interfered by a data signal.

The FFT block 202 performs Fast Fourier Transform on the RS signal stored in the RS buffer 200. That is, the FFT block 202 converts a time domain into a frequency domain.

The RSSI controller 204 accumulates received signal strength of a resource element within a measurement bandwidth with respect to the RS signal which has been subjected to the FFT operation. The received signal strength is accumulated according to each antenna path.

The buffer controller 212 controls the RS buffer 200. The buffer controller 212 determines in which slot of a target cell a reference symbol is stored and which reference symbol is stored. The RS generator generates a reference symbol.

The RSRP controller 205 includes a reference sub-carrier extractor 206, a reference sub-carrier Rx-power accumulator 208 and an RSRP measuring unit 210.

More specifically, the reference sub-carrier extractor 206 extracts a reference sub-carrier from an RS signal which has been subjected to FFT though the FFT block 202. In this case, a data sub-carrier is separated. The reference sub-carrier Rx-power accumulator 208 accumulates received power of a reference sub-carrier extracted by the reference sub-carrier extractor 206. The received power of the reference sub-carrier is accumulated for each antenna path. The RSRP measuring unit 210 measures reference symbol received power (RSRP) including accumulated received power of a reference sub-carrier from the reference sub-carrier Rx-power accumulator 208 and noise power.

The scale converter 226 converts the received signal strength, which is accumulated by the RSSI controller 204, and the RSRP, which is measured by the RSRP controller 205, into a logarithmic scale. Prior to the scale conversion, the received power strength and the RSRP are formed in a linear fashion.

The timing offset controller 215 measures a timing offset from an RS signal, which is extracted from a signal received from a target cell, and a reference sub-carrier, which is extracted from an RS signal. More specifically, the timing offset controller 215 includes a correlation block 216, an Inverse Fast Fourier Transform (IFFT) block 218, a timing impulse accumulator 222, and a peak timing impulse extractor 224.

The correlation block 216 multiplies a reference sub-carrier and a conjugated reference symbol. The multiplication of the conjugated reference symbol is obtained by extracting a reference symbol of a target cell from received reference symbols.

The IFFT block 218 performs Inverse Fast Fourier Transform on a value output from the correlation block 216. That is, the IFFT block 218 converts the multiplied value as a frequency-domain signal into a time-domain signal. A timing impulse value of the reference symbol is then extracted. The timing impulse accumulator 212 accumulates the extracted timing impulse value.

The peak timing impulse extractor 224 extracts a peak timing impulse value from among the accumulated timing impulse values and outputs the peak timing impulse value as a timing offset. The peak timing impulse value indicates delay time of a corresponding neighbor cell. The delay time of a corresponding neighbor cell may be calculated from the timing impulse values accumulated in the timing impulse accumulator 222 for a predetermined interval.

The noise power accumulator 220 measures noise power in a window which is set in a zone of accumulated timing impulse values except the peak timing impulse value. The noise power may be expressed as a ratio of a time index of a window size to a measurement bandwidth. In this case, the noise power is measured in a part of a timing impulse zone which is repeated according to a reference sub-carrier characteristic repeated in a frequency domain following the IFFT operation with respect to the entire measurement bandwidth.

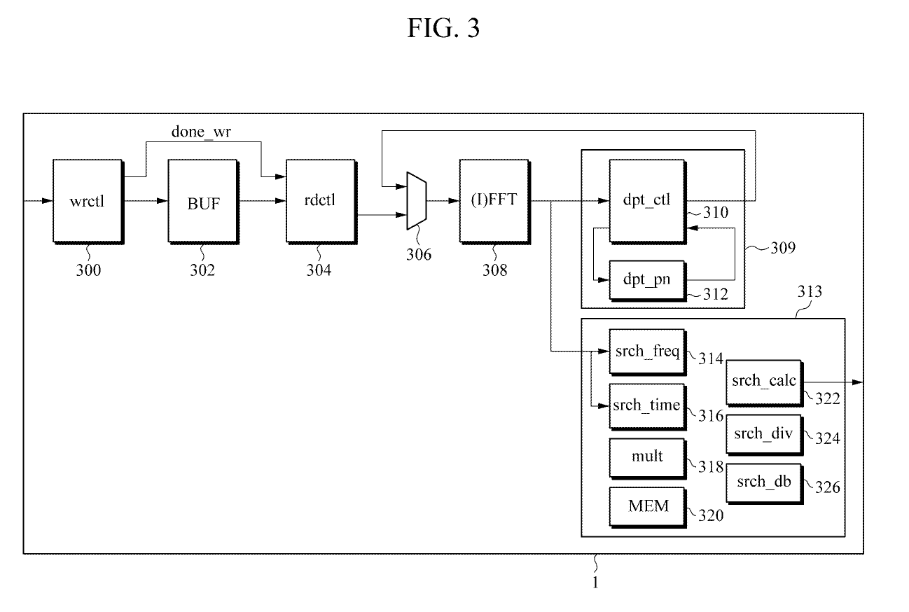

FIG. 3 is a circuit diagram illustrating an example of a mobile communication terminal 1 for measuring a signal received from a neighbor cell according to an exemplary embodiment of the present invention.

Referring to FIG. 3, a wrctl block 300, which corresponds to the buffer controller 212 in FIG. 2, calculates a received timing of a reference symbol of a target cell and calculates which symbol in which slot a received symbol is.

A BUF block 302 is a memory storing a reference symbol therein and corresponds to the RS buffer 200 in FIG. 2. An rdctl block 304 recognizes that the wrctl block 300 has completed buffering control, and outputs a value stored in the BUF block 302 to an (I)FFT block 308. The size of the (I)FFT block 308 is set to a maximum bandwidth which is actually transmitted to a downlink. If a measurement bandwidth is smaller than the maximum bandwidth, the rdctl block 304 controls the remaining bandwidth to be filled with zeros.

A dpt_ctl block 310 in a dpt block 309 receives a reference sub-carrier from a dpt_pn block 312 in real time and performs conjugated multiplication on the reference sub-carrier and received data of the reference sub-carrier.

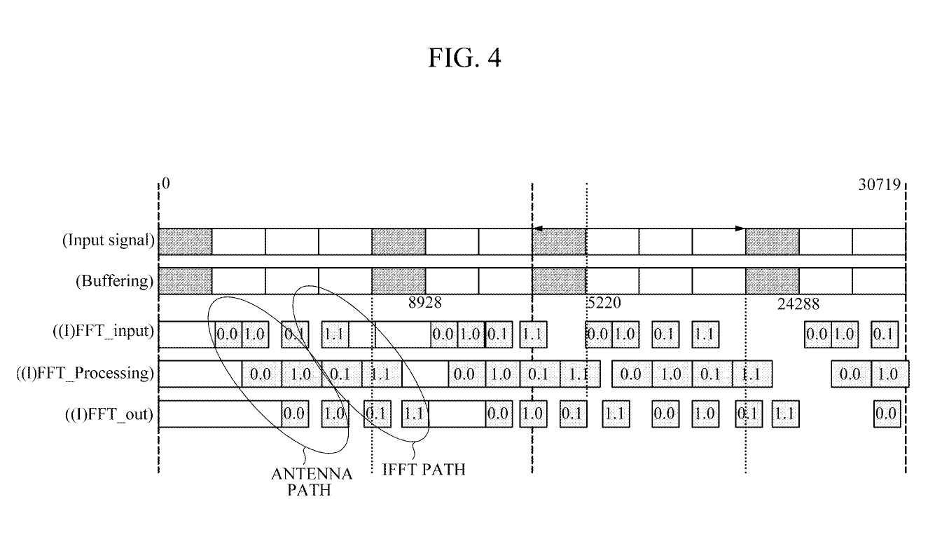

The (I)FFT block 308 repeatedly performs IFFT and FFT on every symbol and employs time sharing to maximize use efficiency. The time sharing of the (I)FFT block 308 will be described with reference to FIG. 4.

A srch_freq block 314 in a srch block 313 measures power of a resource element within a measurement bandwidth. A srch_time block 316 in the srch block 313 selectively stores a single sample area of repeated timing impulse values among the IFFT output result in a buffer and controls a window for noise figure calculation in a time domain.

A mult block 318 is a multiplier. The FFT and IFFT operations do not share the mult block 318 since they overlap each other in terms of time. A MEM block 320 measures power of a received reference signal. A srch_cal block 322 controls a srch_div block 324 and a srch_db block 326. The srch_cal block 322 subtracts linear RS received power and noise power, sets measurement bandwidth and the number of measured sub-frames and performs normalization.

FIG. 4 is a flowchart illustrating each antenna path and a time sharing process per symbol in a mobile communication terminal 1 according to an exemplary embodiment of the present invention.

Referring to FIG. 4, with respect to a signal received from each antenna, the mobile communication terminal 1 compares the mobile communication terminal's clock with a timing offset of each cell, which is received, together with a neighbor cell ID, from a SYNC block, and stores the received signal in a buffer when a reference symbol of a corresponding cell is transmitted. A stored signal of Antenna 0 is then transmitted to the (I)FFT block 308. Next, stored data of Antenna 1 is transmitted to the (I)FFT block 308 according to a strob signal by which an FFT result of Antenna 0 is output.

At this time, an output result of Antenna 0 which has been subjected to FFT operation while data of Antenna 1 is transmitted to the (I)FFT block 308 correlates with a reference symbol generated according to a cell ID and is stored in real time in an input buffer of the (I)FFT block 308 while FFT for Antenna 1 is processed. Next, with a strob signal indicating that the FFT process for Antenna 1 has been completed, IFFT is performed on correlated data of Antenna 0 which is stored in the input buffer of the (I)FFT block 308 Similarly, the FFT output of Antenna 1, which is output in real time, correlates with a reference symbol generated according to cell ID and is stored in real time in the input buffer of the (I)FFT block 308. Operation of storing a new symbol stored in the buffer in the input buffer of the (I)FFT block 308 according to an output strob signal after the IFFT process of Antenna 0 is repeatedly performed in a measurement segment. In (I)FFT_input/(I)FFT_Processing/(I)FFT_out in FIG. 4, a front figure indicates an antenna number, a rear figure of 0 indicates FFT and a rear figure of 1 indicates IFFT.

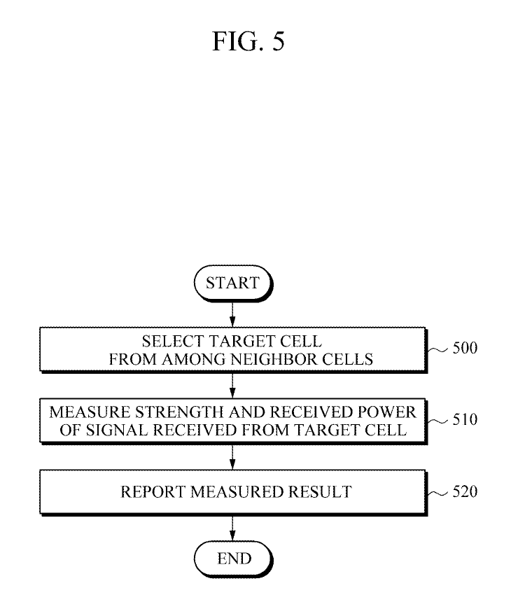

FIG. 5 is a flowchart illustrating an example method of measuring a signal received from a neighbor cell according to an exemplary embodiment of the present invention.

Referring to FIG. 5, in operation 500, the mobile communication terminal 1 selects a target cell from among neighbor cells. More specifically, the mobile communication terminal 1 may select a target cell by referring to a neighbor cell list (NCL) received from a base station of a serving cell and/or by a scanning or synchronization process.

In operation 510, the mobile communication terminal 1 measures the strength and received power of a signal received from the target cell. The mobile communication terminal 1 may measure a received signal strength indicator (RSSI) indicating the signal strength. Further, the mobile communication terminal may measure reference symbol received power (RSRP) indicating the received power of a specific position of each slot of a sub-frame of the received signal.

Further, the mobile communication terminal 1 may measure a timing offset using an RS signal extracted from the signal received from the target cell and a reference sub-carrier extracted from the RS signal. In addition, the mobile communication terminal 1 may measure noise power in a window which is set in a zone of accumulated timing impulse values except a peak timing impulse value. The method of measuring RSSI, RSRP, timing offset and noise power has already been described above with reference to FIGS. 2 and 3. In operation 520, the mobile communication terminal 1 reports the measured result to a radio resource control (RRC) layer.

As apparent from the above description, when the strength or quality of a signal transmitted between a mobile communication terminal and a base station within a serving cell is decreased due to mobility of the mobile communication terminal, it is possible to quickly and accurately measure the strength and received power of the signal received from a neighbor cell neighboring the serving cell. Further, since a cell for providing communication services can be quickly and accurately reselected according to the measured result, it is possible to maintain data transmission quality.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of measuring a signal received from at least one neighbor cell neighboring a serving cell for a mobile communication terminal in mobile communication, the method comprising:
selecting at least one target cell from among the at least one neighbor cell; and
measuring strength and received power of a signal received from the at least one target cell.

2. The method of claim 1, wherein measuring the strength and received power of a signal received from the at least one target cell comprises:
measuring received signal strength indicator (RSSI) indicating the strength of the received signal; and
measuring reference symbol received power (RSRP) indicating the received power of a specific position of each slot of a sub-frame of the received signal.

3. The method of claim 2, wherein measuring the RSSI comprises:
extracting a reference symbol signal from the signal received from the at least one target cell and performing Fast Fourier Transform (FFT) on the extracted reference symbol signal; and
accumulating received signal strength of a resource element within a measurement bandwidth with respect to the reference symbol signal which has been subjected to the FFT operation.

4. The method of claim 3, further comprising converting the accumulated received signal strength of the resource element into a received signal strength indicator expressed on a logarithmic scale.

5. The method of claim 2, wherein measuring the RSRP comprises:
extracting a reference symbol signal from the signal received from the at least one target cell and performing Fast Fourier Transform on the extracted reference symbol signal;
extracting a reference sub-carrier from the reference symbol signal which has been subjected to the FFT operation and accumulating received power of the extracted reference sub-carrier; and
measuring RSRP including the received power of the accumulated reference sub-carrier and noise power.

6. The method of claim 5, further comprising converting the RSRP into a logarithmic scale.

7. The method of claim 1, further comprising measuring a timing offset using a reference symbol signal extracted from the signal received from the at least one target cell and a reference sub-carrier extracted from the reference symbol signal.

8. The method of claim 7, wherein measuring the timing offset comprises:
multiplying the reference sub-carrier by a conjugated reference symbol signal;
performing Inverse Fast Fourier Transform (IFFT) on the multiplied result to extract a timing impulse of a reference symbol signal and accumulating the extracted timing impulse; and
extracting a peak timing impulse from among the accumulated timing impulse and outputting the peak timing impulse as a timing offset.

9. The method of claim 8, further comprising measuring noise power in a window which is set in a zone of the accumulated timing impulse except the peak timing impulse.

10. The method of claim 9, further comprising converting the noise power into a logarithmic scale.

11. The method of claim 1, wherein selecting the at least one target cell from among the at least one neighbor cell comprises selecting the target cell by referring to a neighbor cell list (NCL) received from the base station of the serving cell and/or by a scanning or synchronization process of the mobile communication terminal.

12. The method of claim 1, further comprising reporting the measured result to a radio resource control (RRC) layer.

13. A mobile communication terminal measuring a signal received from at least one neighbor cell neighboring a serving cell for the mobile communication terminal in mobile communication, comprising:
a target cell selecting unit selecting at least one target cell from among the at least one neighbor cell; and
a received signal measuring unit measuring strength and received power of a signal received from the at least one target cell.

14. The mobile communication terminal of claim 13, wherein the received signal measuring unit measures at least one of received signal strength indicator (RSSI) indicating strength of the received signal, reference symbol received power (RSRP) indicating received power of a specific position of each slot of a sub-frame of the received signal, and noise power and timing offset of the received signal.

15. A mobile communication terminal measuring a signal received from at least one neighbor cell neighboring a serving cell for the mobile communication terminal in mobile communication, comprising:
a reference symbol buffer extracting a reference symbol signal from the signal received from the at least one neighbor cell and storing the reference symbol signal therein;
a Fast Fourier Transform (FFT) block performing Fast Fourier Transform on the stored reference symbol;
is an RSSI controller accumulating received signal strength of a resource element within a measurement bandwidth with respect to the reference symbol signal which has been subjected to the FFT operation; and
an RSRP controller extracting a reference sub-carrier with respect to the reference symbol signal which has been subjected to the FFT operation, accumulating received power of the extracted reference sub-carrier, and measuring reference symbol received power (RSRP) including the received power of the accumulated reference sub-carrier and noise power.

16. The mobile communication terminal of claim 15, wherein the received signal strength and the received power of the reference sub-carrier are accumulated for each antenna path.

17. The mobile communication terminal of claim 15, further comprising a scale converter converting the accumulated received signal strength and the reference symbol received power into a logarithmic scale.

18. The mobile communication terminal of claim 15, further comprising a timing offset controller measuring a timing offset using a reference symbol signal extracted from the signal received from the at least one target cell and a reference sub-carrier extracted from the reference symbol signal.

19. The mobile communication terminal of claim 18, wherein the timing offset controller comprises:
a correlation block multiplying the reference sub-carrier by a conjugated reference symbol signal;
an Inverse Fast Fourier Transform (IFFT) block performing IFFT on the multiplied result to extract a timing impulse of a reference symbol signal;
a timing impulse accumulator accumulating the extracted timing impulse; and
a peak timing impulse extractor extracting a peak timing impulse from among the accumulated timing impulse and outputting the peak timing impulse as a timing offset.

20. The mobile communication terminal of claim 19, further comprising a noise power accumulator measuring noise power in a window which is set in a zone of the accumulated timing impulse except the peak timing impulse.
